(19) United States
(12) Patent Application Publication
(10) Pub. No.: US 2007/0234003 A1
(43) Pub. Date: Oct. 4, 2007

(54) Processor device and method for avoiding thrashing

(75) Inventor: Akira Naruse, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 11/483,850

(22) Filed: Jul. 11, 2006

(30) Foreign Application Priority Data
Mar. 31, 2006 (JP) 2006-099349

(51) Int. Cl. G06F 12/00

(52) U.S. Cl. 711/202

(57) ABSTRACT

A physical address in which a cache miss occurs is recorded in a history buffer. A thrashing detector detects thrashing using the history buffer and changes a control flag of a page table. When converting a logical address into the physical address, a page function manager changes the physical address using the changed control flag. A data moving unit moves data from a physical address before being changed to a physical address after being changed.

### BACKGROUND OF THE INVENTION

1. Field of the Invention

The present invention generally relates to a processor device that converts logical addresses into physical addresses. The present invention specifically relates to avoiding thrashing in a processor device.

2. Description of the Related Art

A cache memory is indispensable to speed-up execution of computer programs in a general processor. In other words, the performance of processors has been improving day by day, however, the performance of main storage access has not been able to keep up with the performance of the processors so that cache memories have been used to compensates for slowness of a main storage access.

Increasing a capacity of the cache memory is effective in raising a use rate of the cache memory, i.e., reducing cache misses. Therefore, there is a trend recently toward using large-capacity cache memories. However, cache misses caused by line competition cannot be reduced even by employing large-capacity cache memories.

FIG. 9 is an example of a structure of a typical cache memory. The cache memory is that of a direct map system. The capacity of the cache memory is 64 kilobytes and the line size is 256 bytes. The physical address of the cache memory is 32 bits long. In the physical address, bit 15 to bit 8, i.e., 8 bits, represent the cache line number. FIG. 10A is schematic for explaining a case where line competition has not occurred, and FIG. 10B is a schematic to explain a case where line competition has occurred in the cache memory. FIGS. 10A and 10B assume a case of adding an array b and an array c.

As shown in FIG. 10A, line competition does not occur when line numbers of a cache storing array elements b[i] and c[i] differ from each other. In other words, line competition does not occur because a line number of an array element b[i] and a line number of an array element c[i] differ. The line number of the array element b[i] is [01h], and the line number of the array element c[i] is [81h].

On the other hand, as shown in FIG. 10B, a cache miss caused by line competition occurs when the line numbers of a cache storing the array elements b[i] and c[i] are the same. In other words, line competition occurs because the line number of the b[i] and that of the c[i] are the same, i.e., [81h]. The cache misses continuously occur if the cache is sequentially accessed, from the array elements b[i], c[i], b[i+1], c[i+1], b[i+2], c[i+2], etc. This phenomenon is called thrashing. A computer program takes longer time to end when thrashing occurs.

Coloring, victim cache, and runtime data movement are known as methods for avoiding thrashing. Coloring is a method for avoiding thrashing before the execution of a computer program. In coloring, thrashing is avoided by disposition of data being corrected in a source so that the line competition is not generated. Thrashing is also avoided by the disposition of the data being adjusted so that the line competition is not generated when a compiler compiles a program. A conventional art has been disclosed in, for example, Japanese Laid-open Patent Publication No. 2000-155689.

When a computer program is executing, one way to avid trashing is to use hardware such as a cache memory. FIG. 11 is a diagram for explaining this method. In this method, a victim cache, which is a cache memory having a smaller capacity and a higher associativity than the cache memory (for example, full associative), is used. The victim cache temporarily records data evicted from the cache memory. If thrashing occurs, data in the victim cache is used, so that a penalty (data latency) due to thrashing can be further reduced, compared to when data is read out from a memory. A conventional art has been disclosed in, for example, Japanese Laid-open Patent Publication No. 2001-249846.

The runtime data movement is another method for avoiding thrashing by hardware, when a computer program is executing. In this method, when thrashing is detected, data that causes thrashing is moved (copied) to another region in which competition does not occur. As a result, subsequent thrashing can be suppressed. A conventional art has been disclosed in, for example, Japanese Laid-open Patent Publication No. 2002-116955.

Coloring can be employed only when the source code of the computer program is available. Thus, coloring cannot be employed if source code is not available. Furthermore, even if the source code is available, it is difficult to analyze where a line competition may occur before executing the computer program.

The victim cache reduces a penalty (data latency) caused by thrashing, however, the victim cache is slower than a cache memory. Generally, when data that has not been updated (hereinafter, “clean data”), among the data recorded in the cache memory, is evicted from the cache memory, the clean data is not required to be rewritten into a memory so that the cache memory is not required to send the clean data outside. However, to avoid thrashing using the victim cache, all data evicted from the cache memory are required to be sent to the victim cache. Therefore, changes are required to be made in a method for controlling the cache memory, and a bandwidth from the cache memory to the victim cache is required to be secured. In other words, the method of using a victim cache requires a large amount of additional hardware and therefore it is expensive.

In the runtime data movement, an address, in which the line competition does not occur, is required to be allocated to a region to which the data is moved, to prevent thrashing from being generated. Generally, it is difficult to realize the runtime data movement using hardware. In addition, when the runtime data movement is realized using software (OS), a region securing processing of the OS requires significant modification. Therefore, OS modification costs increase.

Thus, there is a need of a technology that can avoid thrashing at low cost.

### SUMMARY OF THE INVENTION

It is an object of the present invention to at least partially solve the problems in the conventional technology.

According to an aspect of the present invention, a processor device that converts a logical address of data into a physical address includes a thrashing detecting unit that detects thrashing occurring in a cache memory; a control information changing unit that changes control information added to address conversion information corresponding to data that uses a cache line in which thrashing is detected by the thrashing detecting unit thereby changing an original physical address of the data to a new physical address; an address translator that converts the logical address of the data into the physical address by changing an address bit section of the logical address by using the control information; and a data moving unit that moves the data from the original physical address to the new physical address.

According to another aspect of the present invention, a method for avoiding thrashing that is employed on a processor device that converts a logical address of data into a physical address includes detecting thrashing occurring in a cache memory; changing control information added to address conversion information corresponding to data that uses a cache line in which thrashing is detected at the detecting thereby changing an original physical address of the data to a new physical address; converting the logical address of the data into the physical address by changing an address bit section of the logical address by using the control information; and moving the data from the original physical address to the new physical address.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a schematic for explaining address conversion performed by a typical processor device;

FIG. 2 is a schematic for explaining address conversion performed by a processor device according to a first embodiment of the present invention;

FIG. 3 is a schematic for explaining how thrashing is avoided in the first embodiment;

FIG. 4 is a functional block diagram of the processor device according to the first embodiment;

FIG. 5 is a diagram for explaining the address conversion method according to the first embodiment;

FIG. 6 is a diagram for explaining address conversion by using two-bit inversion;

FIG. 7 is a diagram for explaining address conversion by using two-bit addition;

FIG. 8 is a functional block diagram of a processor device according to a second embodiment of the present invention;

FIG. 9 is a diagram for explaining the structure of a cache memory;

FIG. 10A is a diagram for explaining why line competition occurs, and FIG. 10B is a diagram for explaining why line competition does not occur; and

FIG. 11 is a diagram for explaining how thrashing can be avoided by using a victim cache.

### DETAILED DESCRIPTION OF THE PREFERRED EMBODIMENTS

Exemplary embodiments of the present invention are below described with reference to the accompanying drawings. In the following description it is assumed that the cache hierarchy and the address translator have one level. However, a skilled in the art can modify the embodiments to apply it to a processor device including a multi-level cache memory and a multi-level address translator.

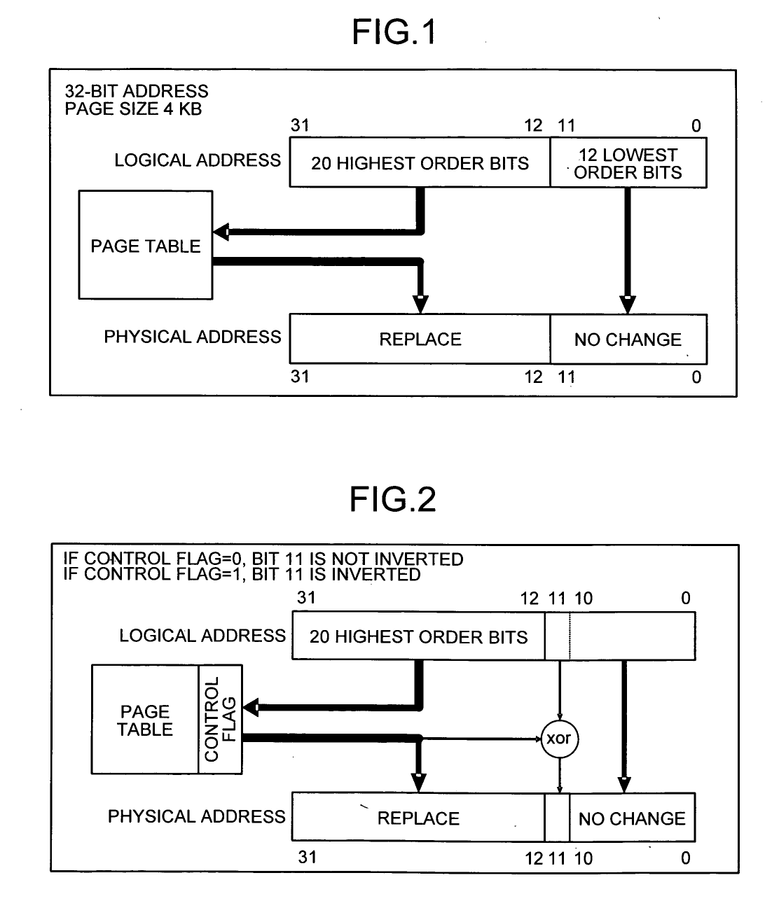

The address conversion performed by a processor device according to a first embodiment of the present invention is explained below. FIG. 1 is a schematic for explaining address conversion performed by a typical processor device and FIG. 2 is a schematic for explaining address conversion performed by a processor device according to a first embodiment of the present invention.

As shown in FIG. 1, when a typical processor device performs address conversion, for example, 20 highest order bits of the 32-bit logical address are replaced with 20 highest order bits of a physical address by using a page table. Moreover, 12 lowest order bits of the logical address are used as the 12 lowest order bits of the physical address, as is.

As shown in FIG. 2, a processor device according to the first embodiment includes a page table that stores therein a one-bit control flag as control information. The control flag corresponds to each combination of the logical address and the physical address. The address translator replaces the 20 highest order bits of the logical address with the 20 highest order bits of the physical address by using the page table. In addition, the address translator takes an exclusive logical sum (xor) of bit 11, among the 12 lowest order bits of the logical address, and the control flag, and determines the sum to be bit 11 of the physical address.

As a result, according to the first embodiment, bit 11 of the physical address can be changed by changing a value of the control flag, thereby changing a cache line number. In other words, address conversion is performed in the first embodiment by controlling a cache line number based on a control flag.

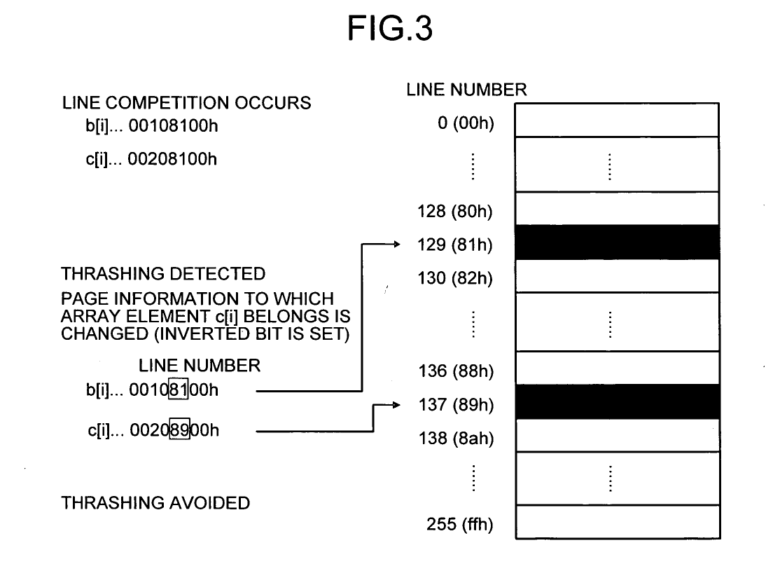

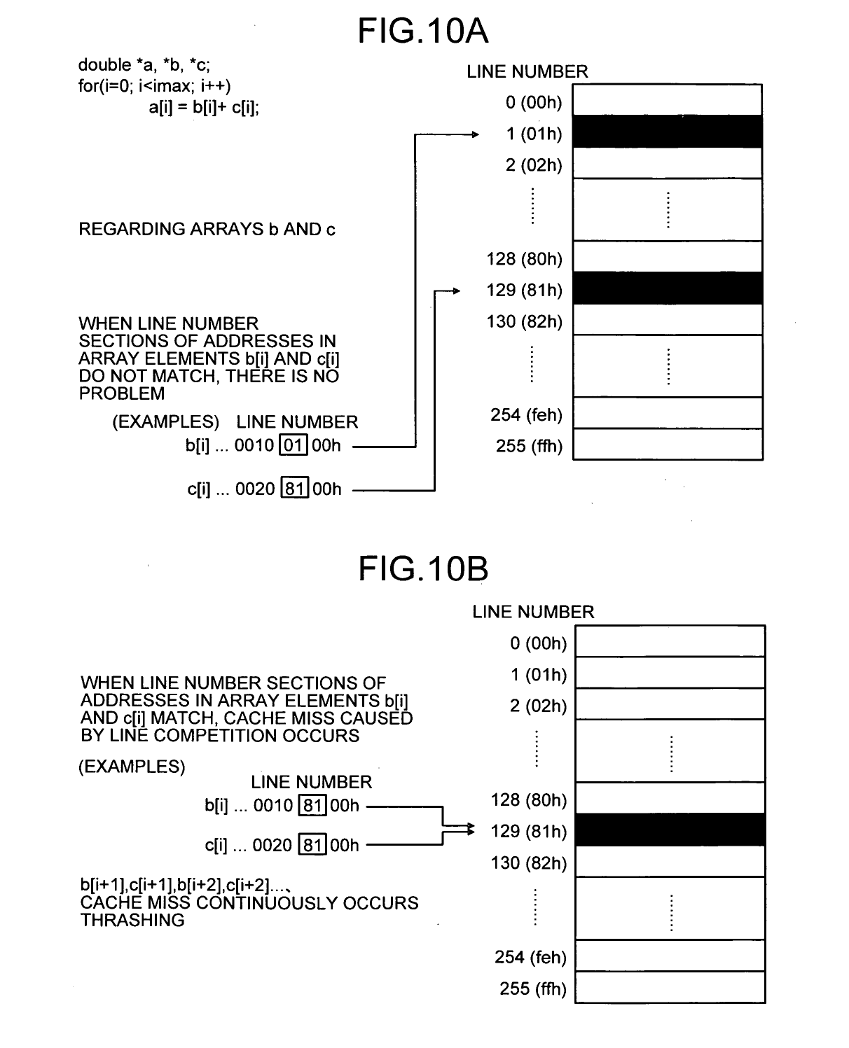

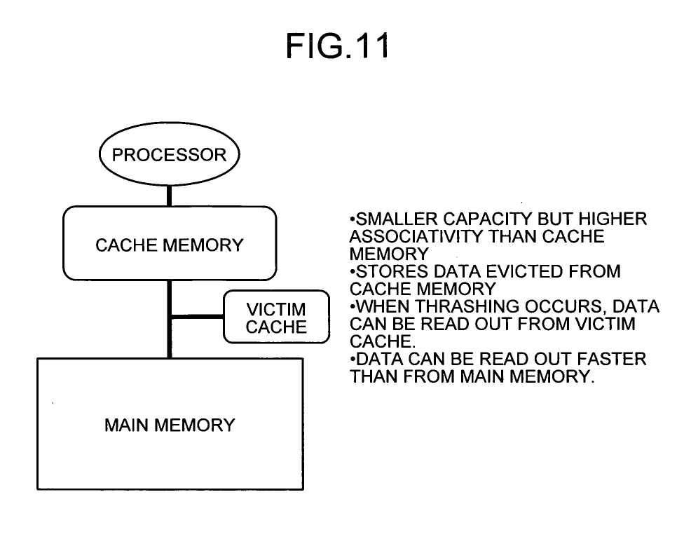

For example, when the line competition, such as that explained with respect to FIG. 10B, occurs, a line number of an array element c[i] is changed from [81h] to [89h], as shown FIG. 3, by changing the control flag from [0] to [1]. The control flag is that of a page to which the array element c[i] belongs. This eliminates the line competition occurring between array elements b[i] and c[i], thereby allowing thrashing to be avoided.

As described above, in the processor device according to the first embodiment, each entry of the page table has the one-bit control flag. When converting the logical address into the physical address, the address translator takes the exclusive logical sum of bit 11 of the logical address and the control flag, and determines the sum to be bit 11 of the physical address. Therefore, when thrashing occurs, the cache line number can be changed by inverting the control flag, and thrashing can be easily avoided.

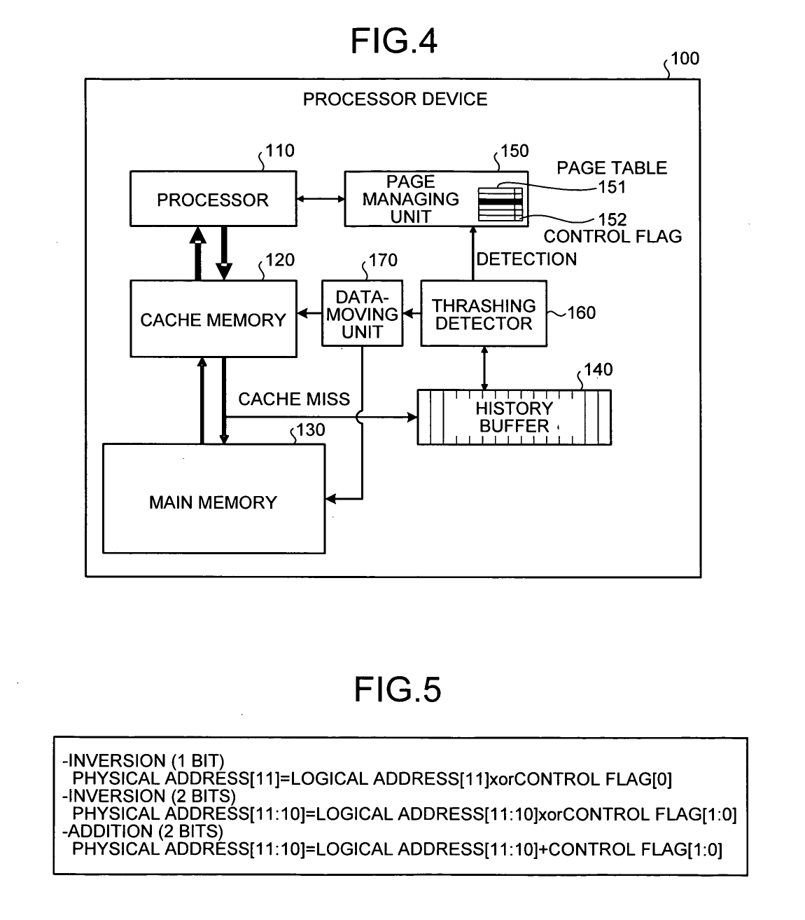

FIG. 4 is a functional block diagram of a processor device 100 according to the first embodiment. The processor device 100 includes a processor 110, a cache memory 120, a main memory 130, a history buffer 140, a page managing unit 150, a thrashing detector 160, and a data-moving unit 170.

The processor 110 extracts and performs commands stored in the main memory 130, extracts any data required to perform the commands from the main memory 130, and stores the data in the main memory 130 when necessary after the commands are performed.

The cache memory 120 temporarily stores the commands and the data stored in the main memory 130. The cache memory 120 can be accessed at a higher speed than the main memory 130. The processor 110 can read and write the commands and the data at a high speed, when the commands and the data are stored in the cache memory 120.

The history buffer 140 is a queue that stores physical addresses in which cache misses occurs. The history buffer 140 stores only a predetermined number of the physical addresses, in the order in which the cache misses occur.

The page managing unit 150 is a converting unit that converts the logical address into the physical address, using a page table 151. The page table 151 stores address conversion information indicating a correspondence between the logical address and physical address.

The page table 151 includes a control flag 152 in each entry. As shown in FIG. 2, when converting the logical address into the physical address, the page managing unit 150 takes the exclusive logical sum of bit 11 of the logical address and the control flag 152 and determines the sum to be bit 11 of the physical address.

As described above, when converting the logical address into the physical address, the page managing unit 150 takes the exclusive logical sum of bit 11 of the logical address and the control flag 152 and determines the sum to be bit 11 of the physical address. As a result, the line number of the cache memory 120 can be changed using the control flag 152.

The page managing unit 150 takes the exclusive logical sum of bit 11 of the logical address and the control flag 152 and determines the sum to be bit 11 of the physical address, using a one-bit control bit as the control flag 152. However, address conversions can also be performed by other methods. FIG. 5 is a diagram of several address conversion methods, including the method of taking the exclusive logical sum of bit 11 of the logical address and the control bit.

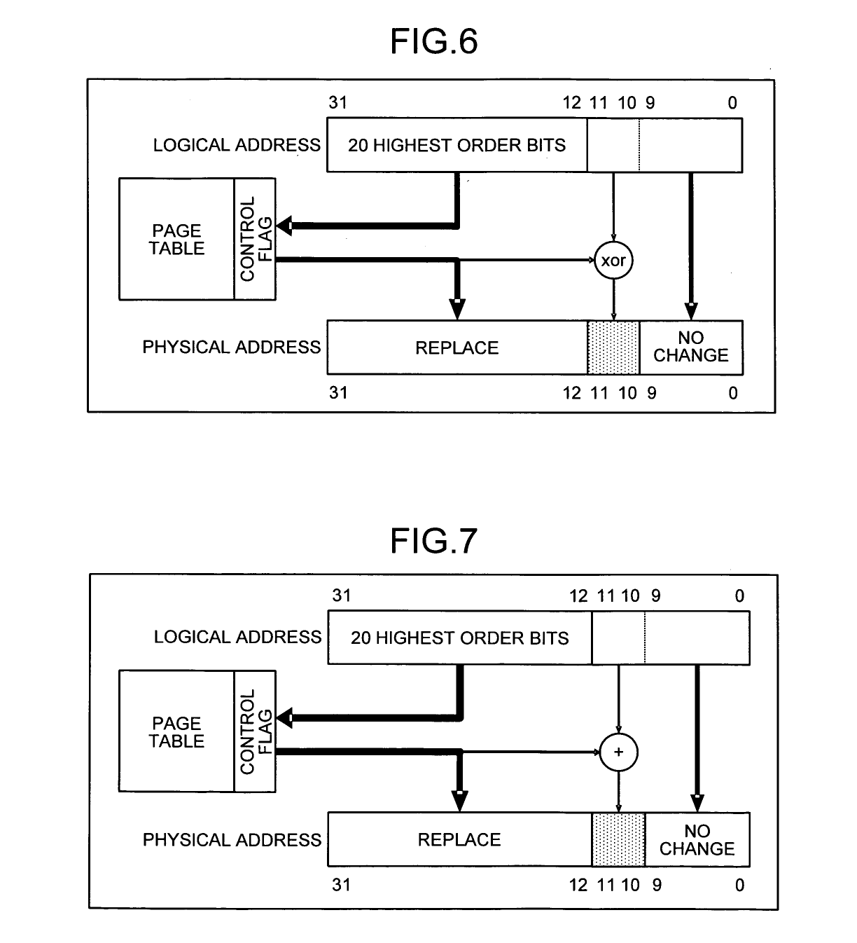

As shown in FIG. 5 and FIG. 6, bit 11 and bit 10 of the physical address (physical address [11:10]) can be also determined by the exclusive logical sum of bit 11 and bit 10 of the logical address (logical address [11:10]) and the control flag (control flag [1:0]), using a two-bit control flag.

In addition, as shown in FIG. 5 and FIG. 7, bit 11 and bit 10 of the physical address can be also determined by addition of the control flag to bit 11 and bit 10 of the logical address, in place of the exclusive logical sum. Various methods, such as computation of the logical address and the control flag, and methods related to a number of bits used as the control flag, can be implemented in the address conversion using a control flag.

The thrashing detector 160 is a processing unit that monitors the history buffer 140 and detects thrashing. Specifically, the thrashing detector 160 counts a number of redundant physical addresses among the physical addresses stored in the history buffer 140. The thrashing detector 160 detects thrashing when the number of the redundant physical addresses reaches a predetermined number or more.

In the first embodiment, only the physical addresses are stored in the history buffer 140 and the thrashing detector 160 counts the number of the redundant physical addresses among the physical addresses stored in the history buffer 140. However, the following method can be also used. The history buffer 140 includes a counter in each entry. Respective counters count a number of times a cache miss occurs at the physical addresses recorded in each entry. The thrashing detector 160 detects thrashing when a counter value reaches a predetermined value or more.

In addition, when thrashing is detected, the thrashing detector 160 inverts the control flag 152 of the entry in which thrashing occurs, in the page table 151 of the page managing unit 150.

As described above, when thrashing occurs, the thrashing detector 160 inverts the control flag 152 of the entry in which thrashing occurs in the page table 151. When converting the logical address into the physical address, the page managing unit 150 takes the exclusive logical sum of bit 11 of the logical address and the control flag 152 and determines the sum to be bit 11 of the physical address. As a result, the physical address of data in which thrashing occurs can be changed, and thrashing can be easily avoided.

When thrashing is detected, the thrashing detector 160 instructs the data-moving unit 170 to move data from a physical address before being changed to a physical address after being changed. The data is that of which the physical address is to be changed by the control flag 152.

The data-moving unit 170 is a processing unit that moves the data, of which the physical address is changed, from the physical address before being changed to the physical address after being changed to avoid thrashing, based on the instruction from the thrashing detector 160.

The data-moving unit 170 moves the data, of which the physical address is changed, from the physical address before being changed to the physical address after being changed to avoid thrashing. As a result, the data can correspond with the change in the physical address.

As described above, in the first embodiment, the physical address in which the cache miss occurs is recorded in the history buffer 140. The thrashing detector 160 detects thrashing using the history buffer 140, and inverts the control flag 152 of the page table 151. When converting the logical address into the physical address, the page managing unit 150 changes the physical address using the inverted control flag 152. The data-moving unit 170 transports the data from the physical address before being changed to the physical address after being changed. Subsequently, the cache misses due to the line competition can be reduced. In other words, thrashing can be avoided.

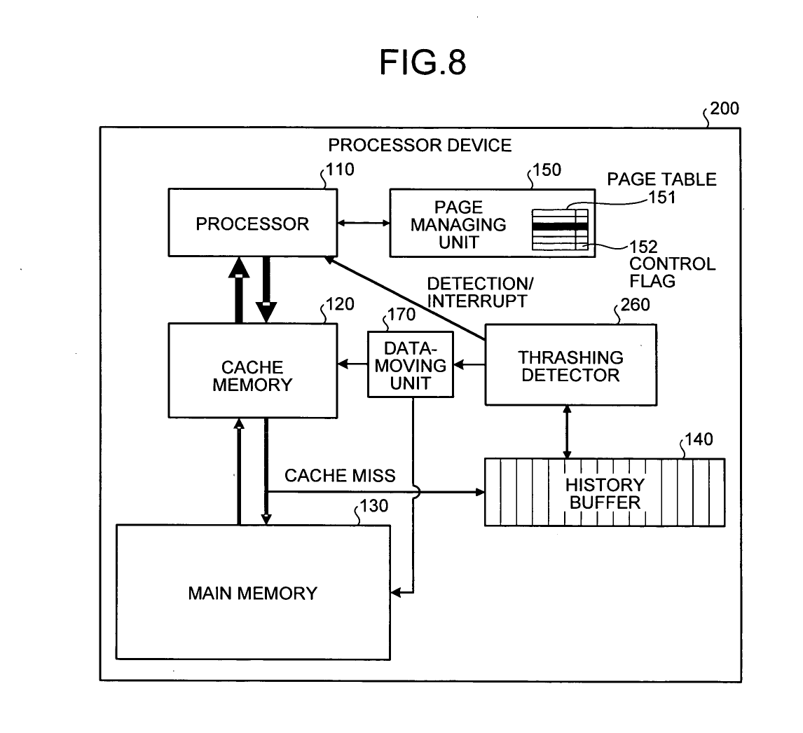

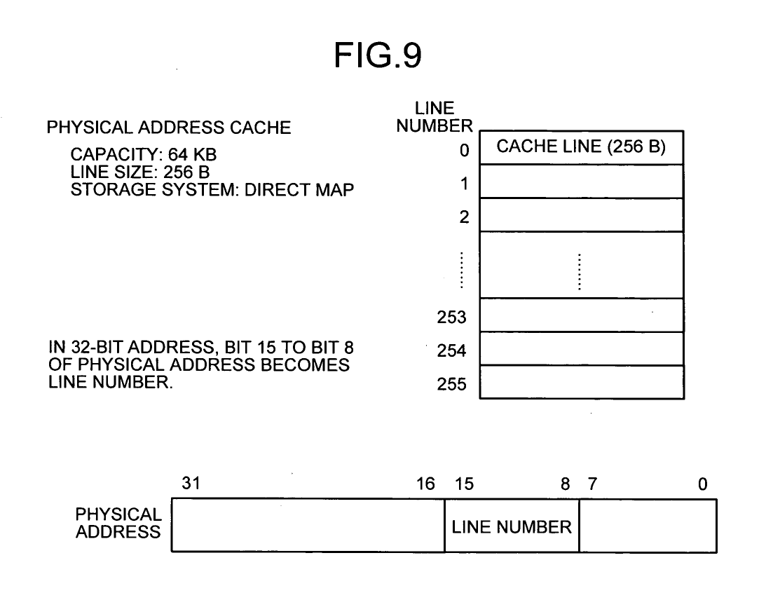

It has been explained that the thrashing detector 160 inverts the control flag 152 of the page table 151, however, the control flag 152 can also be inverted by using software. FIG. 8 is a functional block diagram of a processor device 200 according to a second embodiment of the present invention in which the control flag 152 is inverted by using software. Detailed explanations of functional units performing the same functions as components shown in FIG. 4 are given the same reference numbers, and detailed explanations thereof are omitted.

As shown in FIG. 8, the processor device 200 includes a thrashing detector 260 in place of the thrashing detector 160 in the processor device 100 shown in FIG. 4. The thrashing detector 260 detects thrashing using the history buffer 140 as does the thrashing detector 160. However, when thrashing is detected, the processor 110 generates an interrupt, rather than inverting the control flag 152 of the page table 151.

When the interrupt is generated, the processor 110 inverts the control flag 152 of the page table 151 during interrupt processing. An interrupt processing program can reverse the control flag 152, as such. As a result, the thrashing detector can be further simplified, compared to when the thrashing detector reverses the control flag 152.

The data-moving unit 170 moves the data from the physical address before being changed to the physical address after being changed, based on the instruction from the thrashing detector. The data is that of which the physical address is to be changed by the inversion of the control flag 152, after being converted by the page managing unit 150. However, software can also perform data movement. In other words, the processor 110 can move the data as a processing of the interrupt generated by the thrashing detector.

According to the embodiments, thrashing can be avoided at low cost.

Although the invention has been described with respect to a specific embodiment for a complete and clear disclosure, the appended claims are not to be thus limited but are to be construed as embodying all modifications and alternative constructions that may occur to one skilled in the art that fairly fall within the basic teaching herein set forth.

What is claimed is:

1. A processor device that converts a logical address of data into a physical address, the processor device comprising:
a thrashing detecting unit that detects thrashing occurring in a cache memory;
a control information changing unit that changes control information added to address conversion information corresponding to data that uses a cache line in which thrashing is detected by the thrashing detecting unit thereby changing an original physical address of the data to a new physical address;
an address translator that converts the logical address of the data into the physical address by changing an address bit section of the logical address by using the control information; and
a data moving unit that moves the data from the original physical address to the new physical address.

2. The processor device according to claim 1, wherein the control information is one-bit information, and the control information changing unit changes the one-bit control information.

3. The processor device according to claim 1, wherein
the control information is two-bit information, and
the control information changing unit changes the two-bit control information.

4. The processor device according to claim 1, wherein the address translator performs an exclusive logical operation of the address bit section and the control information for converting the logical address into the physical address.

5. The processor device according to claim 1, wherein the address translator performs an add-subtract operation on the address bit section and the control information for converting the logical address into the physical address.

6. The processor device according to claim 1, wherein the thrashing detecting unit detects occurrence of the thrashing based on a number of redundant physical addresses present in a history queue that sequentially stores physical addresses in which cache misses occur.

7. The processor device according to claim 1, wherein the thrashing detecting unit records physical addresses in which cache misses occur and detects occurrence of the thrashing based on a value of a counter in a history buffer that counts a number of times the cache misses occur in the physical address.

8. The processor device according to claim 1, wherein
the thrashing detecting unit notifies a processor of an interrupt upon detecting the thrashing, and
the control information changing unit changes, when the thrashing detecting unit notifies the interrupt to the processor, the control information added to the address conversion information corresponding to data in which thrashing is detected.

9. The processor device according to claim 1, wherein
the thrashing detecting unit notifies the processor of the interrupt upon detecting thrashing, and
the data moving unit is a processor that moves data, when the thrashing detecting unit notifies the interrupt to the processor, from the original physical address to the new physical address.

10. A method for avoiding thrashing that is employed on a processor device that converts a logical address of data into a physical address, the method comprising:
detecting thrashing occurring in a cache memory;
changing control information added to address conversion information corresponding to data that uses a cache line in which thrashing is detected at the detecting thereby changing an original physical address of the data to a new physical address;
converting the logical address of the data into the physical address by changing an address bit section of the logical address by using the control information; and
moving the data from the original physical address to the new physical address.

11. The method according to claim 10, wherein
the control information is one-bit information, and
the changing includes changing the one-bit control information.

12. The method according to claim 10, wherein
the control information is two-bit information, and
the changing includes changing the two-bit control information.

13. The method according to claim 10, wherein the converting includes performing an exclusive logical operation of the address bit section and the control information for converting the logical address into the physical address.

14. The method according to claim 10, wherein the converting includes performing an add-subtract operation on the address bit section and the control information for converting the logical address into the physical address.

15. The method according to claim 10, wherein the detecting includes detecting occurrence of the thrashing based on a number of redundant physical addresses present in a history queue that sequentially stores physical addresses in which cache misses occur.

16. The method according to claim 10, wherein the detecting includes recording physical addresses in which cache misses occur and detects occurrence of the thrashing based on a value of a counter in a history buffer that counts a number of times the cache misses occur in the physical address.

17. The method according to claim 10, wherein
the detecting includes notifying a processor of an interrupt upon detecting the thrashing, and
changing includes changing, when the interrupt is notified to the processor at the detecting, the control information added to the address conversion information corresponding to data in which thrashing is detected.

18. The method according to claim 10, wherein
the detecting includes notifying a processor of an interrupt upon detecting the thrashing, and
a processor performs the moving that includes moving data, when the thrashing detecting unit notifies the interrupt to the processor, from the original physical address to the new physical address.
